(19) United States
(12) Patent Application Publication
(10) Pub. No.: US 2013/0220751 A1
(43) Pub. Date: Aug. 29, 2013

(54) DUST LIP FOR SHOCK ABSORBER

(71) Applicant: Mando Corporation, (US)

(72) Inventor: Jin Won Seo, Jeollabuk-do (KR)

(73) Assignee: MANDO CORPORATION, Pyeongtaek-Si (KR)

(21) Appl. No.: 13/776,089

(22) Filed: Feb. 25, 2013

(30) Foreign Application Priority Data
Feb. 24, 2012 (KR) 10-2012-0019058

(51) Int. Cl. F16F 9/32

(52) U.S. Cl. CPC F16F 9/32
USPC 188/322.17

(57) ABSTRACT

Provided is a dust lip for a shock absorber, which is provided between a dust cover and a piston rod to prevent foreign substances from flowing into an oil sealing unit in twice and eliminate noise generated by mutual interference between a piston rod and a bumper rubber. The dust lip for the shock absorber includes: a piston rod; a base shell through which a part of the piston rod passes such that the piston rod is exposed to one side; a cap member covering one end of the base shell through which the piston rod passes; a bumper rubber attached to an outer periphery of the exposed portion of the piston rod; and a dust lip provided between the piston rod and the cap member to remove a gap between the piston rod and the cap member.

### CROSS-REFERENCE(S) TO RELATED APPLICATION

This application claims priority of Korean Patent Application No. 10-2012-0019058, filed on Feb. 24, 2012, in the Korean Intellectual Property Office, which is hereby incorporated by reference in its entirety.

### BACKGROUND OF THE INVENTION

1. Field of the Invention

The present invention relates to a suspension for use in a vehicle, that is, a shock absorber, and more particularly, to a dust lip for a shock absorber, which is provided between a dust cover and a piston rod to prevent foreign substances from flowing into an oil sealing unit in twice and eliminate noise generated by mutual interference between a piston rod and a bumper rubber.

2. Description of the Related Art

In the existing vehicles, various types of suspensions are used for improving steering performance or ride comfort. In particular, a suspension combined with a spring, that is, a shock absorber, is used between wheels or a vehicle body so as to absorb vibration or shock.

Typically, a shock absorber includes a cylinder filled with working fluid, a piston mounted on an end of a rod to reciprocate within the cylinder, and a valve provided in the piston.

As shown in FIG. 1, a conventional shock absorber includes a piston rod 3 passing through an upper portion of a base shell 1 forming an outer appearance of a cylinder to perform a straight line motion, a cap member 5 covering the upper portion of the base shell 1 through which the piston rod 3 passes, and a bumper rubber 7 attached to an outer peripheral surface of the piston rod 3 exposed to the exterior.

In such a conventional shock absorber, during a compression stroke, a lower end of the bumper rubber is pushed into a gap between the piston rod and the cap member. Thus, interference with the piston rod is generated and friction noise is caused.

Also, foreign substances penetrate into the gap between the piston rod and the cap member, and the penetrated foreign substances are deposited on an oil seal installed in the upper portion of the base shell, resulting in oil leakage.

### SUMMARY OF THE INVENTION

An aspect of the present invention is directed to provide a dust lip for a shock absorber, which removes a gap between a piston rod and a cap member.

According to an embodiment of the present invention, a dust lip for a shock absorber includes: a piston rod; a base shell through which a part of the piston rod passes such that the piston rod is exposed to one side; a cap member covering one end of the base shell through which the piston rod passes; a bumper rubber attached to an outer periphery of the exposed portion of the piston rod; and a dust lip provided between the piston rod and the cap member to remove a gap between the piston rod and the cap member.

The dust lip may include: a cylindrical body, whose center is penetrated from one side to the other side; a wedge portion, whose outer periphery is inclined toward one side at one end of the cylindrical body; a latch portion protruding from the other end of the cylindrical body along an outer periphery; and a fitting groove formed concavely between the wedge portion and the latch portion.

The dust lip may be fixedly installed such that a part of the cap member is fitted into the fitting groove.

The wedge portion may be inserted into a lower inner periphery of the bumper rubber during a compression stroke of the piston rod, so that a length of the lower inner periphery of the bumper rubber is temporarily expanded.

The dust lip may be an independent type dust lip formed of an elastic body.

The dust lip may be integrally formed with the cap member.

### BRIEF DESCRIPTION OF THE DRAWINGS

FIG. 1 is a perspective view showing a main part of a conventional shock absorber.

FIG. 2 is a perspective view showing a main part of a shock absorber according to the present invention.

FIG. 3 is a perspective view showing a dust lip for a shock absorber according to the present invention.

FIG. 4 is a usage state diagram showing the contact between a bumper rubber and a dust lip during a compression stroke according to the present invention.

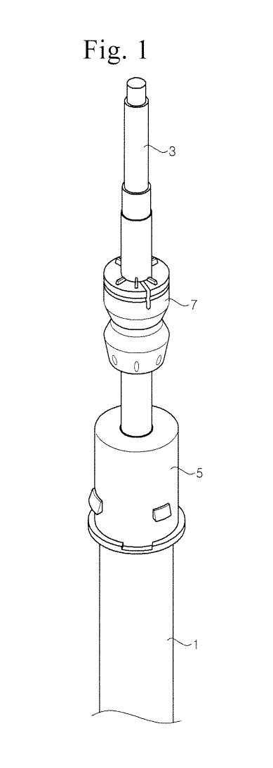

<Description of Reference Numerals>

| | |
|---|---|
| 11: base shell | 13: piston rod |
| 17: bumper rubber | 20: cap member |
| 30: dust lip | 31: cylindrical body |
| 33: wedge portion | 35: latch portion |
| 37: fitting groove | |

### DETAILED DESCRIPTION OF EXEMPLARY EMBODIMENTS

Exemplary embodiments of the present invention will be described below in detail with reference to the accompanying drawings. However, the present invention is not limited to the exemplary embodiments of the present invention. Throughout the disclosure, like reference numerals refer to like parts throughout the drawings and embodiments of the present invention.

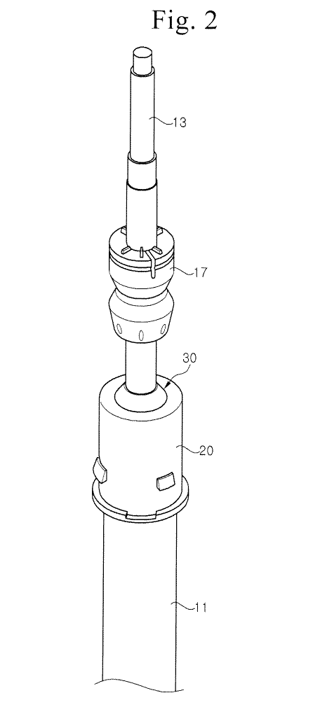

FIG. 2 is a perspective view showing a main part of a shock absorber according to the present invention.

As shown in FIG. 2, a cap member 20 according to the present invention is attached to an upper end of a base shell 11. As in the related art, a rod guide (not shown) for guiding a straight line motion and an oil seal (not shown) for sealing working oil filled within a cylinder are installed in an upper portion of the base shell 11 forming the outer appearance of the cylinder. A bumper rubber 17 is attached to an outer peripheral surface of the piston rod 13 which passes through one end of the base shell 11 and is exposed upward. Generally, when the piston rod 13 is in a compression stroke, the bumper rubber 17 comes into contact with the cap member 20.

As shown in FIG. 2, a dust lip 30, which is a distinctive element of the present invention, is installed in an upper central opening portion of the cap member 20. The dust lip 30 fills a gap between the cap member 20 and the piston rod 13, which passes through the upper central portion of the cap member 20 and performs a piston motion. Thus, foreign substances are prevented from penetrating into the gap between the piston rod 13 and the cap member 20, and the dust lip 30 serves to remove foreign substances adhered to the outer peripheral surface of the piston rod 13. In this way, the penetration of foreign substances are prevented in twice. In one embodiment, the dust lip 30 can be independently manufactured and be assembled with the cap member 20 by press fit. In another embodiment, the dust lip 30 can be molded into the injection-molded cap member 20. As in one embodiment, in the case where the dust lip 30 is independently manufactured, it is advantageous to form the dust lip 30 of an elastic body, such as rubber or plastic, in terms of durability upon the friction with the piston rod 13 or the contact with the bumper rubber 17. However, the dust lip 30 can also be formed of a metal or the like. In addition, in the case where the dust lip 30 is independently manufactured, the independent-type dust lip 30 can be assembled with the typical cap member 20 by press fit. Therefore, the application range can be widened and the manufacturing cost can be reduced.

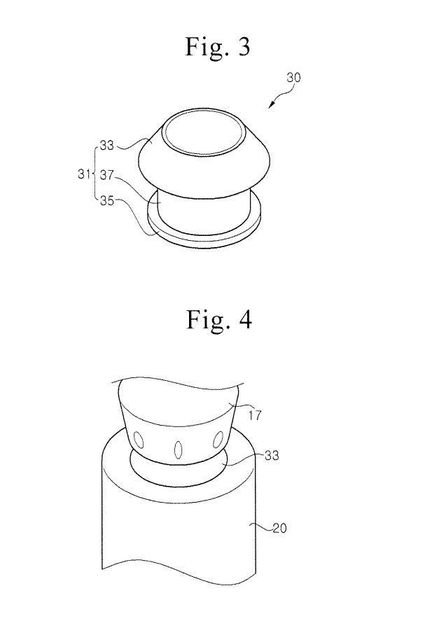

FIG. 3 is a perspective view showing the dust lip for the shock absorber according to the present invention.

As shown in FIG. 3, the dust lip 30 forms a cylindrical body 31, and the center of the dust lip 30 is vertically penetrated. In addition, an upper outer periphery of the cylindrical body 31 forms a conical wedge portion 33 that is inclined such that the circumferential length becomes shorter toward the upper side. In the cylindrical body 31, a latch portion 35 protruding in an outer circumferential direction is formed in a side opposite to the wedge portion 33. A fitting groove 37 is formed between the wedge portion 33 and the latch portion 35. The outer periphery of the fitting groove 37 is concavely formed. When the dust lip 30 is assembled with the cap member 20, the upper end of the cap member 20 is inserted into the fitting groove 37. Thus, the upper end of the cap member 20 is supported to the wedge portion 33 in the upper side, and is supported to the latch portion 35 in the lower side. In this way, the dust lip 30 is fixed to the cap member 20.

FIG. 4 is a usage state diagram showing the contact between the bumper rubber and the dust lip during the compression stroke according to the present invention.

As shown in FIG. 4, when the piston rod 13 is in the compression stroke, the wedge portion 33 is inserted into a lower inner periphery of the bumper rubber 17, so that the inner periphery of the bumper rubber 17 is temporarily expanded. Therefore, the present invention can prevent the problem of the related art that the friction noise is generated by interference between the lower inner periphery of the bumper rubber 17 and the piston rod 13 when the lower inner periphery of the bumper rubber 17 is pushed inward while the bumper rubber 17 is pressed against the cap member 20 during the compression stroke of the piston rod 13.

As described above, the dust lip for the shock absorber according to the present invention is provided between the cap member and the piston rod to effectively prevent foreign substances from flowing into the gap therebetween. Therefore, it is possible to prevent oil leakage from the cylinder due to foreign substances deposited on the upper side of the oil seal. Furthermore, the friction noise is prevented by blocking the interference between the bumper rubber and the piston rod.

As described above, according to the present invention, the gap between the piston rod and the cap member is removed so that foreign substances are prevented from flowing into the cap member. Therefore, sealing performance is reinforced and oil leakage from the piston is prevented.

According to the present invention, foreign substances are removed from the surface of the piston rod during the compression stroke. Therefore, foreign substances are prevented from flowing into the cap member in twice.

According to the present invention, the effect of friction noise elimination is obtained by preventing mutual interference between the lower end of the bumper rubber and the piston rod during the compression stroke.

While the embodiments of the present invention have been described with reference to the specific embodiments, it will be apparent to those skilled in the art that various changes and modifications may be made without departing from the spirit and scope of the invention as defined in the following claims.

What is claimed is:

1. A dust lip for a shock absorber, comprising:
a piston rod;
a base shell through which a part of the piston rod passes such that the piston rod is exposed to one side;
a cap member covering one end of the base shell through which the piston rod passes;
a bumper rubber attached to an outer periphery of the exposed portion of the piston rod; and
a dust lip provided between the piston rod and the cap member to remove a gap between the piston rod and the cap member.

2. The dust lip according to claim 1, wherein the dust lip comprises:
a cylindrical body, whose center is penetrated from one side to the other side;
a wedge portion, whose outer periphery is inclined toward one side at one end of the cylindrical body;
a latch portion protruding from the other end of the cylindrical body along an outer periphery; and
a fitting groove formed concavely between the wedge portion and the latch portion.

3. The dust lip according to claim 2, wherein the dust lip is fixedly installed such that a part of the cap member is fitted into the fitting groove.

4. The dust lip according to claim 2, wherein the wedge portion is inserted into a lower inner periphery of the bumper rubber during a compression stroke of the piston rod, so that a length of the lower inner periphery of the bumper rubber is temporarily expanded.

5. The dust lip according to claim 1, wherein the dust lip is an independent type dust lip formed of an elastic body.

6. The dust lip according to claim 1, wherein the dust lip is integrally formed with the cap member.
